(19) United States
(12) Patent Application Publication
(10) Pub. No.: US 2023/0063340 A1
(43) Pub. Date: Mar. 2, 2023

(54) SYSTEM AND METHOD OF DRILLING A WELLBORE USING WELLBORE AND SURFACE GRAVITY SENSING

(71) Applicant: Halliburton Energy Services, Inc., Houston, TX (US)

(72) Inventors: Jeffrey James Crawford, Houston, TX (US); Christopher Michael Jones, Houston, TX (US); Boguslaw Wiecek, Houston, TX (US)

(73) Assignee: Halliburton Energy Services, Inc., Houston, TX (US)

(21) Appl. No.: 17/894,704

(22) Filed: Aug. 24, 2022

Related U.S. Application Data
(60) Provisional application No. 63/260,662, filed on Aug. 27, 2021.

(51) Int. Cl. E21B 44/00; G01V 99/00; G01V 7/06; E21B 7/04; E21B 49/00

(52) U.S. Cl. CPC E21B 44/00; G01V 99/005; G01V 7/06; E21B 7/04; E21B 49/00; E21B 2200/20

(57) ABSTRACT

A system for drilling a wellbore into an earth formation includes a logging tool in the wellbore having at least one near-range measurement sensor, and a processor. The processor is configured to receive, at each depth along the wellbore, near-range measurement data and reference data related to a density of the formation, determine one or more near-range earth models that include a density model of a layer at each depth based on the near-range data constrained by the reference data, receive surface gravitational data from multiple surface locations, determine a mid-range or far-range formation model based on the near-range earth model and the surface gravitational data, and provide the mid-range or far-range formation model to a well driller for geosteering a drill bit into the earth formation.

### CROSS-REFERENCE TO RELATED APPLICATIONS

This application claims the benefit of priority under 35 U.S.C. § 119(e) to U.S. Provisional Patent Application Ser. No. 63/260,662 titled FORMATION EVALUATION USING DOWNHOLE AND SURFACE GRAVITY SENSING and filed Aug. 27, 2021, the disclosure of which is herein incorporate by reference in its entirety.

### BACKGROUND

This section is intended to provide relevant background information to facilitate a better understanding of the various aspects of the described disclosure. Accordingly, these statements are to be read in this light and not as admissions of prior art.

Wellbores drilled into subterranean formations may enable recovery of desirable fluids (e.g., hydrocarbons) using any number of different techniques. Currently, drilling operations may require information on downhole characteristics to aid in decision-making processes. Numerous measurement techniques are used, including logging while drilling (LWD) and measuring while drilling (MWD) to identify subterranean formations through the use of sensors and testing tools that are part of a bottom hole assembly (BHA) or other downhole tool.

Existing methods for taking measurements by wireline, MWD, LWD, or formation testing tools are generally related to measuring very near-range wellbore properties, for example distances ranging from inches up to a few feet into the formation. Extending measurements from near-range wellbore to mid wellbore—for example from a few feet to up to tens of feet into the formation—may provide additional information regarding the wider subsurface environment. It may be desirable to further extend information about the reservoir and formation into the far wellbore regime which may range from tens of feet to hundreds of feet from the wellbore. However, measurements accurate in the near-range wellbore region may lack sufficient resolution when extended further than the data may permit. Additionally, techniques capable of determining subsurface formation structures in the mid-range and far-range wellbore regions may be costly, impractical, or difficult to implement.

A need exists to extend the depth of measurements into the formation while maintaining an acceptable level of resolution of the measurements to be useful in the drilling process by extending data obtained in the near-range wellbore regions to further distances from the wellbore.

### BRIEF DESCRIPTION OF THE DRAWINGS

Aspects of the formation evaluation systems and methods are described with reference to the following figures. The same or sequentially similar numbers are used throughout the figures to reference like features and components. The features depicted in the figures are not necessarily shown to scale. Certain features of the aspects may be shown exaggerated in scale or in somewhat schematic form, and some details of elements may not be shown in the interest of clarity and conciseness.

FIG. 1 illustrates an example formation evaluation system used with a drilling system;

FIG. 2 illustrates an example of a formation evaluation system used with a wireline system;

FIG. 3 illustrates an example of a measurement assembly of the formation evaluation assembly of FIG. 1 or 2; and

FIG. 4 illustrates a method of extending data related to subsurface formations from near-range wellbore distances to farther distances from the wellbore.

### DETAILED DESCRIPTION

This disclosure generally relates to formation or reservoir property measurements made by wireline, MWD, and LWD sensors where the formation measurement information is processed in combination with a wellbore reference and measurement data along with surface gravimetric measurements. In this manner, measurement data from wellbore sensors may be extrapolated to locations deeper into the formation from the wellbore. The formation properties may be more representative than either wellbore measurements or surface measurements alone.

In subsurface drilling for oil or other liquid extractable resources from underground geological strata, it is important to direct the drill into the strata containing the extractable resources. Such resources may be associated with certain types of strata. It is therefore necessary to determine the type of strata into which the drill is directed. The strata may be characterized by any of a number of physical properties including, as one non-limiting example, the resistivity of the strata material or a density of the strata material. Additional methods for characterizing the strata material may include, but are not limited to, acoustic, NMR, and imaging techniques such as high-frequency imaging techniques and ultrasonic imaging techniques. Additional characterizing data may include nuclear data such as pulse neutron data, gamma ray source/gamma ray detector data, and passive gamma detection data. It is useful to characterize the strata during the drilling operation, so that the direction and orientation of the drill may be adjusted in real time. This real time determination of strata characteristics is part of the logging while drilling (LWD) process.

Not only is it important to characterize the strata immediately adjacent to the wellbore, but it is also important to characterize the strata extending at some distance orthogonal to the wellbore direction (azimuthal strata data). Depending on the measurement used, the data characterizing the wellbore strata may extend in the near-range regime (inches to feet from the wellbore) or in the mid-range range (feet to tens of feet from the wellbore). In this manner, the drill bit may be directed closer to strata that may contain the extractable resources, a process termed “geosteering.”

It may be recognized that multiple strata may be disposed in the subsurface formation, either radiating laterally from the wellbore, along the line of the wellbore, or a combination thereof. Multiple strata may be separated by discontinuities, or there may be faults within a stratum. Accurate models of the subterranean formation may include not only identifications of each stratum, but the location of the discontinuities separating adjacent strata. Inversion algorithms may be used to model the subterranean formation based on the resistivity or density data measured by the logging tool.

In some aspects, a combination of surface gravimetric measuring with at least one downhole measurement and at least one wellbore reference may be used to provide data for at least one of a local mid-range wellbore feature inversion algorithm, a local mid-range wellbore reservoir feature inversion algorithm, a large reservoir scale model inversion algorithm, or a formation earth model inversion algorithm. In some non-limiting examples, the earth model may include a basin model or a reservoir production model.

The wellbore reference data may include measurements that are physically or directly indicative of the density of the formation. The relationship between the reference data and the density of formation strata may be empirical, semi-empirical, local, global, physics-based, or a combination ro combinations thereof. The relationship may be derived from, but not limited to, historical data (such as offset well data, survey data including, but not limited to, seismic survey data, acoustic survey data, or gravimetric survey data), simulation data, or first principle physics, or combination or combinations thereof. The wellbore reference data may also include a formation property. In some aspects, a downhole logging tool may be used to provide a bulk density measurement at varying wellbore depths. Other non-limiting examples of a wellbore reference data may include data from a wellbore gamma ray source/gamma ray detector, wellbore neutron density data, wellbore acoustic density data, and wellbore nuclear magnetics resonance (NMR) data. Additionally, photometric formation probing could take place with photodiodes, photodiode arrays, photomultiplier tubes (PMTs), crystal vacancy detectors, or even another hollow cathode lamp. The density of the wellbore fluid and tool string as well as wellbore geometry can also serve as a reference in the local downhole measurement. Other wellbore reference data may be obtained from one or more of a core sample analysis, a cutting sample analysis, a formation fluid analysis, a wellbore composition analysis, and a pressure transient analysis. Such data may provide physical properties of the wellbore strata, for example strata density, compressibility, and gas/oil ratio, among others. The drilling string and/or downhole logging tool may further provide estimates of fluid types, such as water, oil, and gas and the contact locations of such fluids.

At least one wellbore reference may be a downhole gravimetric measurement. For example, downhole, hollow cathode metal ion lasers could be pressure tuned, buffer gas tuned, or Raman tuned, and mode locked to provide the cooling effect for quantum state probing in the wellbore. Preferably, the measurements are taken while the sensors are stationary, and even then vibration dampening may be used. Such measurements can be taken while drilling or, in case of the wireline, while moving the sensors. Alternatively, such measurements may be made under stationary conditions when all activity ceases during the measurement. It may be understood that the latter condition would be the preferred due to the possibility of interference from drilling or any motion activities.

Near-range wellbore measurement devices may include, but are not limited to, electromagnetic (shallow resistivity and deeper resistivity), acoustic, NMR, and imaging techniques such as high-frequency imaging techniques and ultrasonic imaging techniques. Additional near-range wellbore measurement data may include nuclear data such as pulse neutron, gamma ray source/gamma ray detector data, and passive gamma detection data. The wellbore measurement data may be direct measurements of strata density, or may be relatable to strata density. Near-range wellbore measurement data may include data obtained from physical samples taken from the wellbore, such as cutting samples, core samples, and formation fluid samples. Additional near-range wellbore data may be obtained from pressure transient analysis of the wellbore and physical properties of the wellbore strata, for example density, compressibility, and compositional analysis. In some additional aspects, the near-range measurement data may also include reference data depending on the penetration depth of the reference measurement into the strata near the wellbore. It may be understood that any one or combination of such near-range wellbore measurements may be used or derivative measurements obtained therefrom. Exemplary derivative measurements may include, but are not limited to, lithology, density, porosity, permeability, mineralogy, and fluid type. The combination reference data, near-range wellbore data, and surface gravitational data may also be useful to develop improved reservoir models and earth models.

As disclosed above, multiple sensors may be used to measure the wellbore strata density. A wellbore gravimetric sensor can also provide inclination and azimuth measurements since it is capable of performing three axis gravity measurements and three axis rotation measurements. These measurements may provide additional precision orientation measurement of the wellbore in the presence of magnetic interference. In addition to a wellbore gravimetric sensor, a downhole gyroscopic system combined with magnetic sensors could also be used to determine any magnetic interference due to metal depots within the strata. In one aspect, magnetic interference caused by the well casing may be known due to the magnetic properties of the wellbore casing material. Any magnetic measurements inconsistent with only the magnetic properties of the wellbore casing material may be due to the magnetic properties found within the strata layer itself. The magnetic properties of various materials found in the strata—such as a metallic deposit (for example copper)—may be known. Thus, the magnetic measurement inconsistencies may be modeled by the magnetic properties of the casing as changed or altered by an appropriately chosen metal component that may be found in the strata layer near the wellbore. Combining the known orientation obtained from gyroscopic system in the logging tool with the magnetic measurements provided by magnetic sensors may permit additional calculation of any magnetic interference caused by the strata in which the borehole is drilled.

The system disclosed herein includes surface gravity sensors that determine the location of fine features to great depth within the subsurface. For example, the surface gravity sensors may be quantum gravity sensors that provide resolution of micro- to nano-G measurements. Knowledge of feature dimensions and size may be used to constrain the inversion algorithm for the properties of the formation of interest. Typically, the inversion algorithm starts with an initial model of the strata, including a number of layers at a measured depth and a property of each layer (for example, layer material density) extending horizontally or radially from the wellbore. The gravitational measurement at a given surface location is an aggregate measurement of all of the mass or density of strata along the line of the gravitation normal measured at each surface location of surface gravity sensors. If feature dimensions are known at a particular depth in the strata from the surface gravity sensor, then a layer size modeled by the inversion algorithm at that depth must also be consistent with the feature dimensions and size determined by the surface gravity sensor at its gravitational normal as measured at the distance of the surface gravity sensor from the wellbore. That is, the layer mass at the intersection of the wellbore depth (extending radially from the wellbore) and the gravitational normal of the surface gravity sensor must be consistent between the inversion algorithm model at that depth and normal location and the surface gravitational measurement at the same depth and normal location

In some aspects, the gravitational data may be corrected for gravitational anomalies, for example those caused by the wellbore and the drilling string themselves. Multiple surface gravity sensors may be deployed around a wellbore in any arrangement for optimal ranging of the BHA. In one aspect, the multiple surface gravity sensors may be deployed in a pattern to triangulate the wellbore location. Additionally, the multiple gravity sensor data may provide a local gravimetric survey of the subsurface formations into which the wellbore has been drilled. Alternatively, a single surface gravity sensor may be used at multiple locations around the wellbore to provide similar gravimetric data.

The systems and methods may be used to take a totality of measurements to provide formation density, formation fluid density, and porosity estimates. The sensitivity of formation fluid density measurements can provide reservoir architecture, compartmentalization information, compositional grading, and local structure such as lenses, pinchouts, faults and similar. The use of such data by the inversion algorithm of the reservoir model or earth model could provide better well planning or better reservoir simulations. An inversion algorithm (see below) includes a wellbore measurement of the strata at a particular wellbore depth. The inversion model then starts with an initial estimate of the strata including a number of layers and the layer properties (such as density or composition). The inversion model then simulates the wellbore measurement with the initial model layers and iteratively alters the model layers until the simulated wellbore measurements are consistent with the wellbore measurement. The final model may then be considered a “convergent” model. However, multiple initial estimated models may all result in consistent simulated wellbore measurements although the final (convergent) model from each of the initial models may differ. As a result, the subsurface earth structure would not be well determined, and it would be difficult to predict where the drill should be steered to obtain recoverable resources. However, if additional data are available for the inversion model, such data being formation density, formation fluid density, and porosity estimates, then the inversion algorithm will include those additional data to constrain the initial and subsequent models of the individual strata layers. Such constraints including, but not limited to, the types and densities of materials at a given wellbore depth and distance from the wellbore. The resulting inversion algorithm models, based on multiple independent types of data, may provide better estimates of the subterranean earth structure. The more accurate models may then be used to direct where the drill bit may be steered for a better probability of finding the recoverable material.

An inversion algorithm may start with an initial estimated model of a subterranean formation to describe the subterranean formation, such as, for example, a number of strata layers, and a randomly assigned wellbore measurement value for each layer. The wellbore measurement data, such as resistivity data, may provide indirect characterizations of the layer densities. The initial model may be used with governing equations generate simulation measurements to relate the model to the indirect layer density characterizations from the wellbore measurement data. This initial model may be iteratively modified as explained further below, until the algorithm produces a solution model of the subterranean formation in which the modeled data (simulation measurements) are consistent with the measurement data. A model may be said to converge if the modeled wellbore data are consistent with the measured wellbore measurement data (to within a threshold value or over a set number of iterations). It may be understood that convergence is not guaranteed to be perfect and can be dependent on starting conditions defining the initial model. Sometimes the multiple initial models may converge to the same final layer model. Also the various layer models can be assessed for confidence based on the accuracy and precision of the measurements from which they were constructed. Alternatively, a model may be said to diverge if the modeled wellbore data are inconsistent with the measured data (to within the threshold value or over a set number of iterations). The model of the subterranean formation is achieved when the simulated data are consistent with the measured data.

In some non-limiting aspects, the inversion algorithm may, for example, successively modify the initial model based on a gradient search technique, such as a Gauss-Newton search method. Typically, an inversion algorithm solution may be a one dimensional solution curve of wellbore measurement data versus measurement depth. In some non-limiting aspects, the inversion algorithm may also generate a two dimensional solution of wellbore measurement data versus measurement depth and angular position about the wellbore. The model produced by the inversion algorithm may include, for example, modeled wellbore measurement data over distance or distance and angular position. The modeled wellbore measurement data may be produced by a specific model of the formation defined over a measurement depth. In some aspects, the modeled wellbore measurement data may be compared to the measured wellbore measurement data obtained from measured wellbore data using a least-squares algorithm.

The inversion algorithms may be run using a number of initial models, each defined by an initial set of conditions, each initial model producing modeled wellbore measurement data, in which the resulting layer model may be convergent or divergent (compared to the measured data). Multiple initial models may be run. In some non-limiting examples, hundreds of initial models may be used. For example, initial models may be defined as having one stratum, two strata, three strata, or any countable number of strata. Initially, each stratum may be characterized by a randomly selected wellbore measurement value, such as density. Each of the initial models may result in a new modeled wellbore measurement data derived from a specific model of the formation.

It may be recognized that inversion algorithms may result in multiple models of the strata near the wellbore, each model being consistent with the wellbore measurements. In some aspects, these models may differ only in terms of the thicknesses of the various layers, while the types (defined either by composition or density) and order of the layers from the wellbore may be the same. In other aspects, the models may differ more substantially in terms of number of layers, types of material or density, and order of layers. However, each of these models may converge with respect to the wellbore measurements. It is therefore useful to include initial constraints on the inversion algorithm, to reduce the number of possible conflicting models. In one aspect, reference data may be added to the model. Reference data may be data that characterize either the composition or density of the strata near the wellbore. Non-limiting examples of such reference data may be obtained from one or more of a core sample analysis, a cutting sample analysis, a formation fluid analysis, a down well composition analysis, and a pressure transient analysis. Other examples of reference data have been disclosed above. In this manner, the initial model may be chosen to be consistent with the reference data. Further, as the inversion algorithm continues throughout the iterations, each subsequent model should be consistent not only with the measured wellbore data, but also with the reference data.

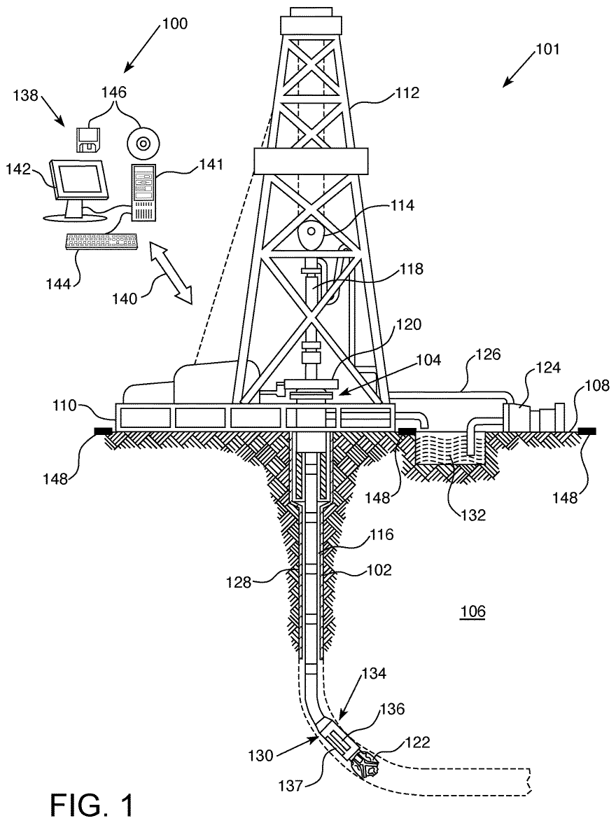

FIG. 1 illustrates an example of a formation evaluation system 100 to be used with a drilling system 101. As illustrated, a wellbore 102 may extend from a wellhead 104 into a subterranean formation 106 from a surface 108. Generally, the wellbore 102 may include horizontal, vertical, slanted, curved, and other types of wellbore geometries and orientations. The wellbore 102 may be cased or uncased. In examples, the wellbore 102 may include a metallic member. By way of example, the metallic member may be a casing, liner, tubing, or other elongated steel tubular disposed in the wellbore 102.

As illustrated, the wellbore 102 may extend through subterranean formation 106. As illustrated in FIG. 1, the wellbore 102 may extend generally vertically into the subterranean formation 106, however the wellbore 102 may extend at an angle through subterranean formation 106, such as horizontal and slanted wellbores. For example, although FIG. 1 illustrates a vertical or low inclination angle well, high inclination angle or horizontal placement of the well and equipment may be possible. It should be further noted that while FIG. 1 generally depicts land-based operations, those skilled in the art may recognize that the principles described herein are equally applicable to subsea operations that employ floating or sea-based platforms and rigs, without departing from the scope of the disclosure.

As illustrated, a drilling platform 110 may support a derrick 112 having a traveling block 114 for raising and lowering drill string 116. The drill string 116 may include, but is not limited to, drill pipe and coiled tubing, as generally known to those skilled in the art. A kelly 118 may support the drill string 116 as it may be lowered through a rotary table 120. A drill bit 122 may be attached to the distal end of the drill string 116 and may be driven either by a downhole motor and/or via rotation of the drill string 116 from surface 108. Without limitation, the drill bit 122 may include, roller cone bits, PDC bits, natural diamond bits, any hole openers, reamers, coring bits, and the like. As the drill bit 122 rotates, it may create and extend the wellbore 102 that penetrates various subterranean formations 106. A pump 124 may circulate drilling fluid through a feed pipe 126 through kelly 118, downhole through an interior of the drill string 116, through orifices in the drill bit 122, back to the surface 108 via an annulus 128 surrounding the drill string 116, and into a retention pit 132.

With continued reference to FIG. 1, the drill string 116 may begin at the wellhead 104 and may traverse the wellbore 102. The drill bit 122 may be attached to a distal end of the drill string 116 and may be driven, for example, either by a downhole motor and/or via rotation of the drill string 116 from the surface 108. The drill bit 122 may be a part of bottom hole assembly (BHA) 130 at a distal end of the drill string 116. It should be noted that BHA 130 may also be referred to as a downhole tool. The BHA 130 may further include tools for look-ahead resistivity applications. As will be appreciated by those of ordinary skill in the art, the BHA 130 may be a measurement-while drilling (MWD) or logging-while-drilling (LWD) system. The BHA 130 may also include directional drilling and measuring equipment such as a push-the-bit or point-the-bit rotary steerable system for examples.

The BHA 130 may comprise any number of tools, transmitters, and/or receivers to perform downhole measurement operations. For example, as illustrated in FIG. 1, the BHA 130 may include a formation evaluation measurement assembly 134. It should be noted that the formation evaluation measurement assembly 134 may make up at least a part of the BHA 130. Without limitation, any number of different measurement assemblies, communication assemblies, battery assemblies, and/or the like may form the BHA 130 with the formation evaluation measurement assembly 134. Additionally, the formation evaluation measurement assembly 134 may form the BHA 130 itself. In examples, the BHA 130 may include about twenty sensors, which may continuously record data in an X direction, Y direction, Z direction, radially, and tangential accelerations, shocks, axial load, torque, inclination, bending, pressure, and temperature, etc. These sensors may operate and/or function in a high frequency band. Without limitation, wide band high frequency accelerometers may measure acceleration, which includes propagating waves.

In examples, the formation evaluation measurement assembly 134 may comprise at least one formation measurement sensor 136. Without limitation, there may be four formation measurement sensors 136 that may be disposed ninety degrees from each other. However, it should be noted that there may be any number of formation measurement sensors 136 disposed along the BHA 130 at any degree from each other. Non-limiting examples of such formation measurement sensors 136 may include wellbore electromagnetic resistivity sensors, wellbore acoustic sensors, wellbore NMR sensors, wellbore imaging sensors, including high-frequency imaging sensors and ultrasonic imaging sensors, nuclear radiation sensors, including pulse neutron sensors, and passive gamma detection sensors. In some aspects, the formation measurement sensors 136 may function and operate, for example, to generate signals that travel through the subterranean formation 106 to measure one or properties of the subterranean formation 106. In other aspects, the formation measurement sensors 136 may sense intrinsic properties of the subterranean formation 106. This information may lead to determining a property of the formation or reservoir as discussed below. Without limitation, the formation measurement sensors 136 may be EM sensors. In examples, the formation measurement sensors 136 may also include backing materials and matching layers. It should be noted that the formation measurement sensors 136 and assemblies housing the formation measurement sensors 136 may be removable and replaceable, for example, in the event of damage or failure.

The BHA 130 also includes sensors 137 to measure at least one wellbore reference property. At least one subsurface downhole measured wellbore reference includes but is not limited to a local wellbore gravimetric measurement measured by a gravimetric sensor on a formation evaluation measurement assembly which may be part of the BHA 130. The wellbore reference may also include additional gravimetric measurements and measurements of other formation properties, such as without limitation, litho-density, porosity, resistivity, as well as other formation properties from near-range wellbore measurements.

Without limitation, the BHA 130 may be connected to and/or controlled by an information handling system 138, which may be disposed on the surface 108 and be part of the formation evaluation system 100. The information handling system 138 may communicate with the BHA 130 through a communication line (not illustrated) disposed in (or on) the drill string 116. In examples, wireless communication may be used to transmit information back and forth between the information handling system 138 and the BHA 130. The information handling system 138 may transmit information to the BHA 130 and may receive as well as process information recorded by the BHA 130. In examples, a downhole information handling system (not illustrated) may include, without limitation, a microprocessor or other suitable circuitry, for estimating, receiving and processing signals from the BHA 130. The downhole information handling system (not illustrated) may further include additional components, such as a memory device, input/output devices, interfaces, and the like. In examples, while not illustrated, the BHA 130 may include one or more additional components, such as an analog-to-digital converter, an electrical signal filter and an amplifier, among others, that may be used to process the measurements of the BHA 130 before they may be transmitted to the surface 108. Alternatively, raw measurements from the BHA 130 may be transmitted to the surface 108.

Any suitable technique may be used for transmitting signals from the BHA 130 to surface 108, including, but not limited to, wired pipe telemetry, mud-pulse telemetry, acoustic telemetry, and electromagnetic telemetry. While not illustrated, the BHA 130 may include a telemetry subassembly that may transmit telemetry data to the surface 108. In one aspect, at the surface 108, pressure transducers (not shown) may convert a pressure signal into electrical signals for a digitizer (not illustrated). The digitizer may supply a digital form of the telemetry signals to information the information handling system 138 via a communication link 140, which may be a wired or wireless link. The telemetry data may be analyzed and processed by the information handling system 138.

As illustrated, a communication link 140 (which may be wired or wireless, for example) may be provided that may transmit data from the BHA 130 to the information handling system 138 at the surface 108. In one aspect, the information handling system 138 may include a personal computer 141, a video display 142, a keyboard 144 (i.e., other input devices.), and/or non-transitory computer-readable media 146 (e.g., optical disks, magnetic disks) that can store code representative of the methods described herein. In addition to, or in place of processing at the surface 108, processing may occur downhole.

The formation evaluation system 100 further includes one or more surface gravity sensors 148. The surface gravity sensors 148 may include, for example, quantum gravity sensors. The surface gravity sensors 148 may be placed at locations at the surface 108 and spaced for optimal ranging of subterranean formation 106 of interest. At least three surface gravity sensors 148 at the surface 108 may also be used. Further, the surface gravity sensors 148 may be arranged in a pattern to triangulate the wellbore 102 location. The surface gravity sensors 148 can remain stationary or can be moved throughout the ranging process, although the surface gravity sensors 148 are fixed during the measurements. The surface gravity sensors 148 measure gravity gradients of the subterranean e formation 106 that can be used to determine one or more properties of the subterranean formation 106. The data measured by the surface gravity sensors 148 may then be communicated to the information handling system 138 via the communication link 140, which may be a wired or wireless communication link.

The gravity data from the surface may be processed by the information handling system 138, in conjunction with the downhole formation measurement data, and the wellbore reference data from the BHA, to determine one or more properties of the subterranean formation 106. Processing the measurements together may extend the range of measurement of near-range wellbore measurements to mid-range, i.e., tens of feet deep into the formation in any radial direction from the wellbore. For example, knowledge of feature dimensions and size can be used to constrain the inversion algorithm using the measurements from the BHA 130. To do so, the wellbore measurements may be augmented by the gravity density measurements from the surface, and locations of stratigraphic features, formation boundaries, and fluid contacts as markers within the wellbore from local sensors on the BHA 130. All information may be used to gain a more representative understanding of a formation or reservoir, thus improving formation property measurements from the BHA 130 by itself, as well as improve Earth models produced from the formation sensor measurements. A discussion of the analysis process is discussed below.

The determined formation information may be used to produce an image, which may be generated into two- or three-dimensional models of the subterranean formation 106 around the wellbore. These models may be used for well planning, (e.g., to design a desired path of the wellbore 102). Additionally, they may be used for planning the placement of drilling systems within a prescribed area. As disclosed above, a driller may wish to deploy the drill bit into productive strata having a high probability of containing recoverable resources through a combination of vertical and horizontal drilling processes. It may be understood that such productive strata may be located at some distance (tens to hundreds of feet) away from the current wellbore trajectory. Images derived from layer models based on only one wellbore measurement may be insufficient to allow a driller to confidently determine the location into which the drill bit may be directed for recoverable resources. In particular, images obtained from near-range models may not provide sufficient information to suggest that the drill bit should be geosteered at some distance away from the current wellbore trajectory. Given the cost of drilling into unproductive strata—both in terms of material used and time—it may be more useful to rely on more accurate subsurface images derived from models resulting from multiple independent data sources. Such additional independent data may also permit a subsurface earth model derived from only near-range data to be extended into the mid-range area, further from the wellbore. As a result, a well driller may be presented with a wider field of view of the subsurface strata to drive the decisions for altering the drill bit path. This may allow the most efficient drilling operations to reach a subsurface structure.

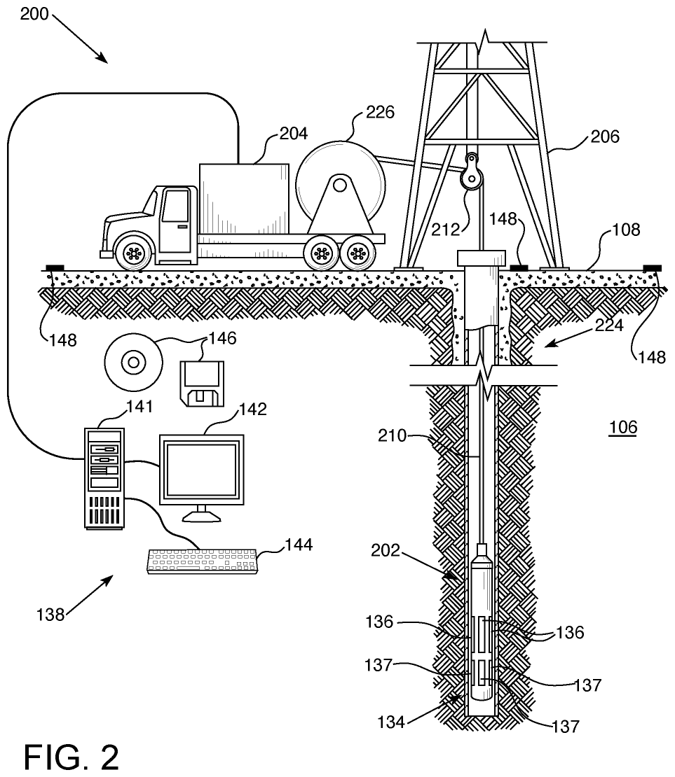

FIG. 2 illustrates a cross-sectional view of an example of a formation evaluation system 200. As illustrated, the formation evaluation system 200 includes a downhole tool 202 attached to a vehicle 204. In examples, it should be noted that the downhole tool 202 may alternatively not be attached to a vehicle 204. The downhole tool 202 may be supported by a rig 206 at a surface 108. The downhole tool 202 may be tethered to the vehicle 204 through a conveyance 210. The conveyance 210 may be disposed around one or more sheave wheels 212 to the vehicle 204. The conveyance 210 may include any suitable means for providing mechanical conveyance for the downhole tool 202, including, but not limited to, wireline, slickline, coiled tubing, pipe, drill pipe, downhole tractor, or the like. In some aspects, the conveyance 210 may provide mechanical suspension, as well as electrical and/or optical connectivity, for the downhole tool 202. The conveyance 210 may include, in some instances, a plurality of electrical conductors and/or a plurality of optical conductors extending from the vehicle 204, which may provide power and telemetry. In examples, an optical conductor may utilize a battery and/or a photo conductor to harvest optical power transmitted from the surface 108. The conveyance 210 may comprise an inner core of seven electrical conductors covered by an insulating wrap. An inner and outer steel armor sheath may be wrapped in a helix in opposite directions around the conductors. The electrical and/or optical conductors may be used for communicating power and telemetry between the vehicle 204 and the downhole tool 202.

Information from the downhole tool 202 may be gathered and/or processed by an information handling system 138. For example, signals recorded by the downhole tool 202 may be stored in the memory device and then processed by the downhole tool 202. The processing may be performed real-time during data acquisition or after recovery of the downhole tool 202. Processing may alternatively occur downhole or may occur both downhole and at surface. In some aspects, signals recorded by the downhole tool 202 may be conducted to the information handling system 138 by way of the conveyance 210. The information handling system 138 may process the signals, and the information contained therein may be displayed for an operator to observe and be stored for future processing and reference. The information handling system 138 may also contain an apparatus for supplying control signals and power to the downhole tool 202.

Systems and methods of the present disclosure may be implemented, at least in part, with the information handling system 138. While shown at the surface 108, the information handling system 138 may also be located at another location, such as remote from the wellbore 102. The information handling system 138 may include any instrumentality or aggregate of instrumentalities operable to compute, estimate, classify, process, transmit, receive, retrieve, originate, switch, store, display, manifest, detect, record, reproduce, handle, or utilize any form of information, intelligence, or data for business, scientific, control, or other purposes. For example, the information handling system 138 may be a personal computer 141, a network storage device, or any other suitable device and may vary in size, shape, performance, functionality, and price. The information handling system 138 may include random access memory devices (RAM), one or more processing resources such as a central processing unit (CPU) or hardware or software control logic, ROM, and/or other types of nonvolatile or non-transitory memory devices. Additional components of the information handling system 138 may include one or more disk drives, one or more network ports for communication with external devices as well as various input and output (I/O) devices, such as a keyboard 144, a mouse, and a video display 142. The information handling system 138 may also include one or more buses operable to transmit communications between the various hardware components. Furthermore, the video display 142 may provide an image to a user based on activities performed by the personal computer 141. In one non-limiting example, the video display 142 may, produce images of geological structures created from recorded signals. By way of example, the video display 142 may produce a plot of depth versus the two cross-axial components of a gravitational field and versus the axial component in borehole coordinates. The same plot may be produced in coordinates fixed to the Earth, such as coordinates directed to the North, East and directly downhole (Vertical) from the point of entry to the borehole. A plot of overall (average) density versus depth in borehole or vertical coordinates may also be provided. A plot of density versus distance and direction from the borehole versus vertical depth may be provided. It should be understood that many other types of plots are possible when the actual position of the measurement point in North, East and Vertical coordinates is taken into account. Additionally, hard copies of the plots may be produced in paper logs for further use.

Alternatively, systems and methods of the present disclosure may be implemented, at least in part, with a non-transitory computer-readable media 146. Non-transitory computer-readable media 146 may include any instrumentality or aggregation of instrumentalities that may retain data and/or instructions for a period of time. The non-transitory computer-readable media 146 may include, for example, storage media such as a direct access storage device (e.g., a hard disk drive or floppy disk drive), a sequential access storage device (e.g., a tape disk drive), compact disk, CD-ROM, DVD, RAM, ROM, electrically erasable programmable read-only memory (EEPROM), and/or flash memory; as well as communications media such wires, optical fibers, microwaves, radio waves, and other electromagnetic and/or optical carriers; and/or any combination of the foregoing.

As illustrated in FIG. 2, a formation evaluation system 200 includes a downhole tool 202 that may include a formation evaluation measurement assembly 134. It should be noted that the formation evaluation measurement assembly 134 may make up at least a part of the downhole tool 202. Without limitation, any number of different measurement assemblies, communication assemblies, battery assemblies, and/or the like may form the downhole tool 202 with the formation evaluation measurement assembly 134.

Additionally, the formation evaluation measurement assembly 134 may form the downhole tool 202 itself. In examples, the downhole tool 202 may include about twenty sensors, which may continuously record data in an X direction, Y direction, Z direction, radially, and tangential accelerations, shocks, axial load, torque, inclination, bending, pressure, and temperature, etc. These sensors may operate and/or function in a high frequency band. Without limitation, wide band high frequency accelerometers may measure acceleration, which includes propagating waves.

In examples, the formation evaluation measurement assembly 134 may comprise at least one formation measurement sensor 136. Without limitation, there may be four formation measurement sensors 136 that may be disposed ninety degrees from each other. However, it should be noted that there may be any number of formation measurement sensors 136 disposed along the downhole tool 202 at any degree from each other. The formation measurement sensors 136 may function and operate, for example, to generate signals that travel through the subterranean formation 106 to measure one or properties of the subterranean formation 106. This information may lead to determining a property of the formation or reservoir as discussed below. Without limitation, the formation measurement sensors 136 may be EM sensors. In examples, the sensors 136 may also include backing materials and matching layers. It should be noted that the formation measurement sensors 136 and assemblies housing the formation measurement sensors 136 may be removable and replaceable, for example, in the event of damage or failure.

The downhole tool 202 also includes sensors 137 to measure at least one wellbore reference. At least one subsurface downhole measured wellbore reference is a gravimetric measurement measured by a gravimetric sensor on the BHA 130. The wellbore reference may also include additional gravimetric measurements and measurements of other formation properties, such as without limitation, litho-density, porosity, resistivity, as well as other formation properties.

Without limitation, the downhole tool 202 may be connected to and/or controlled by an information handling system 138, which may be disposed on the surface 108 and be part of the formation evaluation system 200. The information handling system 138 may communicate with the downhole tool 202 through a communication line (not illustrated). In examples, wireless communication may be used to transmit information back and forth between the information handling system 138 and the downhole tool 202. The information handling system 138 may transmit information to the downhole tool 202 and may receive as well as process information recorded by the downhole tool 202. In examples, a downhole information handling system (not illustrated) may include, without limitation, a microprocessor or other suitable circuitry, for estimating, receiving and processing signals from the downhole tool 202. The downhole information handling system (not illustrated) may further include additional components, such as memory devices, input/output devices, interfaces, and the like. In examples, while not illustrated, the downhole tool 202 may include one or more additional components, such as analog-to-digital converter, filter and amplifier, among others, that may be used to process the measurements of the downhole tool 202 before they may be transmitted to the surface 108. Alternatively, raw measurements from the downhole tool 202 may be transmitted to the surface 108.

The formation evaluation system 200 further may include one or more surface gravity sensors 148. The surface gravity sensors 148 may include, for example, quantum gravity sensors. The surface gravity sensors 148 may be placed at locations at the surface 108 and spaced for optimal ranging of subterranean formation 106 of interest. At least three surface gravity sensors 148 at the surface 108 may also be used. Further, the gravity sensors 148 may be arranged in a pattern to triangulate the wellbore 102 location. The surface gravity sensors 148 can remain stationary or can be moved throughout the ranging process, although the surface gravity sensors 148 should be fixed during the measurements. The surface gravity sensors 148 measure gravity gradients of the subterranean formation 106 that can be used to determine one or more properties of the subterranean formation 106. The data measured by the surface gravity sensors 148 may then be communicated to the information handling system 138 via the communication link 140, which may be a wired or wireless communication link.

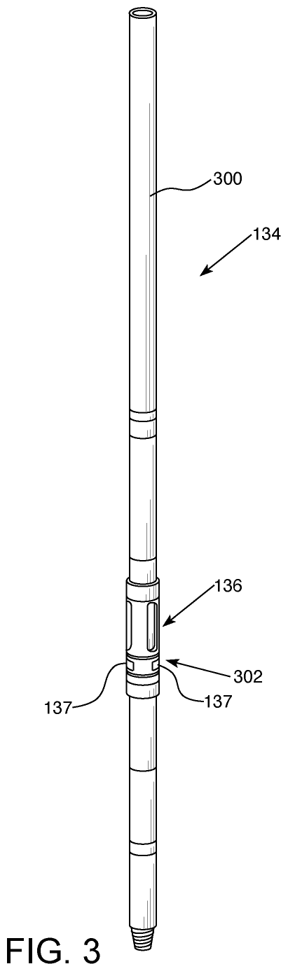

FIG. 3 illustrates a close-up view of an example of formation evaluation measurement assembly 134. As illustrated, the formation evaluation measurement assembly 134 may include at least one battery section 300 and at least one instrument section 302. The battery section 300 may operate and function to enclose and/or protect at least one battery that may be disposed in the battery section 300. Without limitation, the battery section 300 may also operate and function to power the formation evaluation measurement assembly 134. Specifically, the battery section 300 may power at least one formation measurement sensor 136, which may be disposed at any end of the battery section 300 in the instrument section 302.

The instrument section 302 may house at least one formation measurement sensor 136. As described above, the formation measurement sensor 136 may operate to generate signals that travel through the subterranean formation 106 to measure one or properties of the subterranean formation 106. Recordings and/or measurements taken by the formation measurement sensor 136 may be transmitted to the information handling system 138 by any suitable means, as discussed above.

The formation evaluation measurement assembly 134 (e.g., referring to FIGS. 1-3) may comprise a digital subsystem, a multi-transducer subsystem, a multi-sensor subsystem, and a directional subsystem. These subsystems may work together to generate information on one or more properties of the subterranean formation 106. In some examples, a digital controller may act as a central control and communication unit. It should be noted that the digital controller may be a part of the information handling system 138. The digital controller may control at least one sensor to emit a signal into the subterranean formation 106. Additionally, the digital controller may control an analog digital converter (ADC) to sample the reflected echoes. In examples, the directional subsystem may comprise a gyro or magnetometer. These devices may be used to log the downhole tool face and rotation information. The digital controller may control at least one sensor in the formation evaluation measurement assembly 134 to measure a wellbore reference. During measurement operations, the information handling system 138 may combine all measurements from the digital subsystem, the multi-transducer subsystem, the multi-sensor subsystem, and the directional subsystem to generate tool dynamic results, which may be saved into a memory device. It should be noted that tool dynamic results may be transmitted to the surface through the information handling system 138 in any suitable manner as described above.

The gravity data from the surface may be processed by the information handling system 138, in conjunction with the downhole formation and reference measurements from the BHA, to determine one or more properties of the subterranean formation 106. Processing the measurements together extends the range of measurement of what would normally be near-range wellbore measurements to mid-range, i.e., tens of feet deep into the formation in any radial direction from the wellbore. For example, knowledge of feature dimensions and size can help constrain the inversion algorithm of the measurements from the BHA 130. To do so, the wellbore measurements are augmented by the gravity density measurements from the surface, and locations of stratigraphic features, formation boundaries, and fluid contacts as markers within the wellbore from local sensors on the BHA 130. All information may be used to gain a more representative understanding of a formation or reservoir, thus improving formation property measurements from the BHA 130 by itself, as well as improve Earth models produced from the formation sensor measurements.

The determined formation information may be used to produce an image, which may be generated into two- or three-dimensional models of the subterranean formation 106. These models may be used for well planning, (e.g., to design a desired path of the wellbore 102). Additionally, they may be used for planning the placement of drilling systems within a prescribed area. This may allow the most efficient drilling operations to reach a subsurface structure.

In some aspects, the wellbore reference data, near-range wellbore measurement data, and the surface gravitational data may be used to extend the near-range wellbore data further into the mid-wellbore region.

As disclosed above, the inversion algorithms may start with a near-range measurement of strata properties at each of a variety of depths of the wellbore. Reference data taken at each depth are also acquired. The inversion algorithms then generate an initial model of the strata next to the wellbore at each depth. The inversion algorithms then iteratively modify the initial models until convergence is obtained. Convergence of the models may be defined when either the simulated near-rage measurement data are within a predetermined threshold of the measured data and consistent with the reference data, or after a predetermined number of iterations. At this point, the near-range models of the strata are determined at each of the variety of depths that are probed.

Further, as disclosed above, it would be useful to extend the near-range layer models (inches to feet from the wellbore) into the mid-range (feet to tens of feet from the wellbore) and even into the far-range (tens of feet to hundreds of feet from the wellbore). Such models can provide longer-range information regarding the subsurface environment around the wellbore. As indicated above, such models may be useful to geosteer the drill bit from vertical into neighboring strata that may prove productive sources of recoverable fluids. Surface gravimetric data may be used to extend the near-range models into the mid-range and even far-range areas.

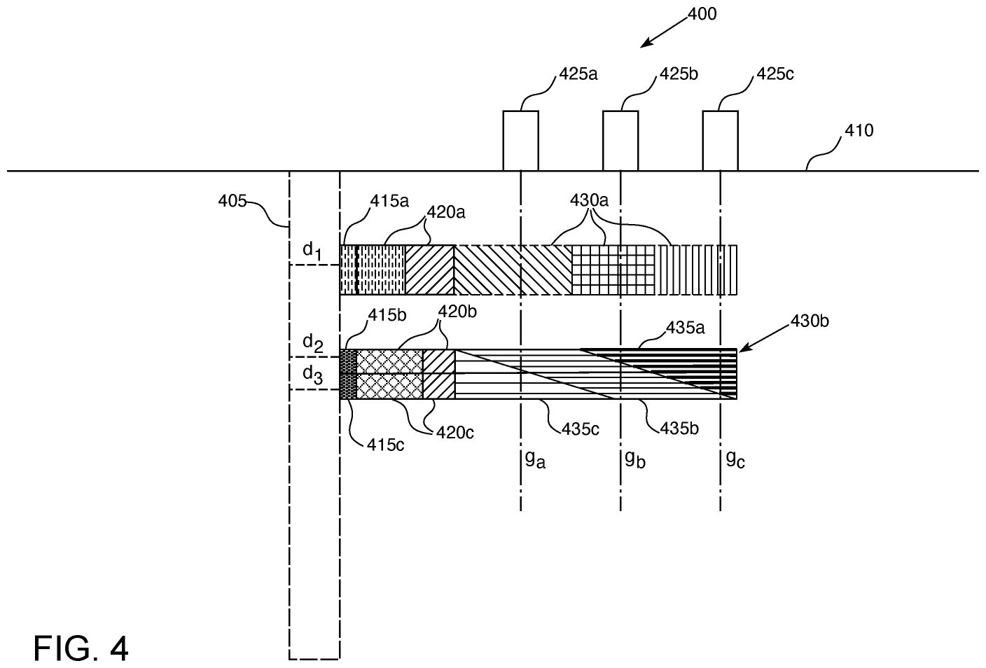

FIG. 4 illustrates a diagram 400 for extending near-range layer models into the mid-range or far-range from a wellbore. A wellbore 405 may be drilled through the subsurface layers. At each depth d1, d2, d3 from the top of the wellbore, (ground surface 410), reference data 415a, 415b, and 415c, respectively, are obtained to characterize the strata adjacent to the wellbore 405. These data provide known measurements of the strata density adjacent to the wellbore 405 at the respective depths d1, d2, d3. Wellbore measurements are made at each depth d1, d2, d3 and the inversion algorithms are run to produce convergent models 420a, 420b, and 420c of the strata extending to the near-range region of the wellbore at each depth, d1 and d2. Convergent models 420a and 420b illustrate modeled strata layers at each depth d 1, d2, d3. A series of surface gravimetric measurements are made by surface gravity detectors 425a,b,c, each characterized by its own gravitational normal ga, gb, gc, respectively. It may be understood that separate g surface ravity detectors 425a,b,c may be used to make the surface gravitational measurements. Alternatively, a single surface gravity detector may be placed at surface locations corresponding to 425a,b,c as illustrated in FIG. 4.

Gravity is an absolute measure of depth and can see out into the far-range region from the wellbore in voxels having dimensions of about 2 meters using nano-gravity techniques. Because the gravitational data have such fine spatial resolution, they can be used by inversion algorithms based on density measurements—or measurements correlated with strata density—to model strata formations up to about 200 ft into the formation from the wellbore. In one non-limiting example, the density related measurement may be based on acoustic measurements, in which the acoustic signal can travel 200 ft or so from the wellbore.

The force of gravity at the surface is measured at a location j (corresponding to one of the surface gravity detectors 425a,b,c) on the surface due to layer i in the subsurface to create a force Fi at location j due to mass mi at layer i using the expression Fgi=G(mi×mj)/r2 were r is the distance between layer i and surface location j. The density of the near wellbore zone can be measured by multiple techniques that correlate with density such as acoustic impedance or neutron density or neutron count, as disclosed above. It is well understood that mass=volume×density. Thus, each mass element occupying a volume may be used to calculate the effect at surface location j (where j may be moved to location 1, 2, 3 etc. as depicted by the locations of surface gravity detectors 425a,b,c).

In one non-limiting example, for example at depth d1, the density of a modeled earth stratum layer may be assumed to be consistent and homogenous at any lateral depth around the wellbore. In this fashion, a distance from the various density elements comprising each stratum layer may be calculated at the various surface positions. Assuming that the bed boundaries in the model do not cross a fault (shift suddenly) and do not cross each other, positions of the model layers and their thicknesses may be iteratively estimated by trading cells across bed boundaries in order to forward model the best Fgi match at the various locations along the surface. The model strata layers 430a can then be extended into the mid-range region due to a combination of lateral constraints at its depth d1 from the wellbore (consistency with the reference data and the measurement data) and vertical constraints at each gravitational normal ga, gb, gc, (consistency with the gravitational measurements at each of the surface gravitational sensors 425a,b,c). As noted above, the extended model of the subsurface strata at each depth (such as d1) may result in additional homogeneous model strata layers 430a located next to the layers derived from the initial inversion algorithms models (415a, 420a).

In some alternatives, the subsurface strata are not laterally homogeneous. For example, at some depths (d2 and d3), the depth and thickness of an inhomogeneous model strata layer 430b may change laterally thereby affecting Fgj at various surface gravitational locations differentially for a given mass. As an example, in a depositional environment, sand deposits 435c may be located near a Paleolithic ocean shore, a silt deposit 435b may be located further from the shore, and a clay deposit 435a may be deposited yet further from shore. Inversion algorithm modeling of the layers individually, using the measurement, reference, and surface gravitational data at each depth d1, d2, and d3 separately, may not be able to properly characterize such an inhomogeneous deposition bed. However, interlayer correlation analyses may reveal such depositional bed structures. Thus, correlations between the models developed at layers at depths d2 and d3 may be made. While the initial near-range inversion models, 420b and 420c, may be essentially the same or similar, the apparent extended inhomogeneous model strata layer 430b may produce different modeling results at the different depths d2 and d3. The surface gravitational measurements made by the surface gravity sensors 425a-c at the different surface locations may be used along with the interlayer model correlations to reveal the structure of such inhomogeneous deposits.

The density may be locally correlated for each formation packages to capture the variance of the formation density as it correlates to other properties such as but not limited to porosity, permeability, fluid mobility, rock mechanical properties, compositional variation, etc. of the various layers. The correlation derived is most simply a univariate correlation to each property. Alternatively a dimensional reduction by method like principle component analysis (PCA) may be performed in order to determine how properties vary as a function of density among the layers. A bivariate or multivariate correlation can be performed with density and along with other low resolution long range measurements such as seismic, borehole seismic, borehole acoustic, electromagnetic, cross well electromagnetic, and magnetic measurements. A physical model may be introduced which may provide information on variations as a function of lateral distance or depth.

One example of a physical model of the layers may include a model of a Paleolithic ocean, which may be determined from geological survey data. Additionally, hydrodynamic analyses of water and sediments along an ocean shore may predict the deposition layering of sand, silt, and clay based on the average energy of the ocean water and near beach turbulence. Such data may provide additional constraints on the modeling of the mid- and far-range models of inhomogeneous strata layering.

Additional constraints may be used to extend the near-range models to the mid- and far-ranges. Thus, geological and magnetic survey data in the area around the wellbore may provide additional information about known layer compositions and orientations. Such data may include knowledge of land and water formations in the geological past from paleo-geographical data. Additionally, wide gravimetric survey data may also help to extend the locally measured gravimetric data. Acoustic data, which can probe to about 200 feet can be an independent measure of the subsurface strata. All of these data may also be used to constrain the mid- and far-range models based on the near-range measurements.

As disclosed above, the near-range and/or far-range earth models may be provided to a well driller to determine how the well drill may be steered into the subterranean earth formation. Thus, the well driller may consider the near-range and/or far-range earth models for geosteering the drill bit. However, in one alternative aspect, the drilling system may be automated, and the processor controlling the operation of the drilling system may use the near-range and/or far-range earth models to automate the geosteering of the drill bit into the subterranean earth formation.

Certain terms are used throughout the description and claims to refer to particular features or components. As one skilled in the art will appreciate, different persons may refer to the same feature or component by different names. This document does not intend to distinguish between components or features that differ in name but not function.

For the aspects and examples above, a non-transitory computer readable medium can comprise instructions stored thereon, which, when performed by a machine, cause the machine to perform operations, the operations comprising one or more features similar or identical to features of methods and techniques described above. The physical structures of such instructions may be operated on by one or more processors. A system to implement the described algorithm may also include an electronic apparatus and a communications unit. The system may also include a bus, where the bus provides electrical conductivity among the components of the system. The bus can include an address bus, a data bus, and a control bus, each independently configured. The bus can also use common conductive lines for providing one or more of address, data, or control, the use of which can be regulated by the one or more processors. The bus can be configured such that the components of the system can be distributed. The bus may also be arranged as part of a communication network allowing communication with control sites situated remotely from system.

In various aspects of the system, peripheral devices such as displays, additional storage memory devices, and/or other control devices that may operate in conjunction with the one or more processors and/or the memory devices. In particular, the one or more processors may be in data communication with the displays, memory devices, and/or control devices. The peripheral devices can be arranged to operate in conjunction with display unit(s) with instructions stored in the memory module to implement the user interface to manage the display of the anomalies. Such a user interface can be operated in conjunction with the communications unit and the bus. Various components of the system can be integrated such that processing identical to or similar to the processing schemes discussed with respect to various aspects herein can be performed.

While compositions and methods are described herein in terms of “comprising” various components or steps, the compositions and methods can also “consist essentially of” or “consist of” the various components and steps.

Unless otherwise indicated, all numbers expressing quantities are to be understood as being modified in all instances by the term “about.” Accordingly, unless indicated to the contrary, the numerical parameters set forth in the following specification and attached claims are approximations that may vary depending upon the desired properties sought to be obtained by the aspects of the present disclosure. At the very least, and not as an attempt to limit the application of the doctrine of equivalents to the scope of the claim, each numerical parameter should at least be construed in light of the number of reported significant digits and by applying ordinary rounding techniques accepted by those skilled in the art.

Reference throughout this specification to “one aspect,” “an aspect,” “an aspect,” “aspects,” “some aspects,” “certain aspects,” or similar language means that a particular feature, structure, or characteristic described in connection with the aspect may be included in at least one aspect of the present disclosure. Thus, these phrases or similar language throughout this specification may, but do not necessarily, all refer to the same aspect.

The aspects disclosed should not be interpreted, or otherwise used, as limiting the scope of the disclosure, including the claims. It is to be fully recognized that the different teachings of the aspects discussed may be employed separately or in any suitable combination to produce desired results. In addition, one skilled in the art will understand that the description has broad application, and the discussion of any aspect is meant only to be exemplary of that aspect, and not intended to suggest that the scope of the disclosure, including the claims, is limited to that aspect.

When introducing elements of various aspects, the articles “a,” “an,” “the,” and “said” are intended to mean that there are one or more of the elements. The terms “comprising,” “including,” and “having” are intended to be inclusive and mean that there may be additional elements other than the listed elements. Also, the term “couple” or “couples” is intended to mean either an indirect or direct connection. Thus, if a first device couples to a second device, that connection may be through a direct connection of the two devices, or through an indirect connection that is established via other devices, components, nodes, and connections. In addition, as used herein, the terms “axial” and “axially” generally mean along or parallel to a given axis (e.g., central axis of a body or a port), while the terms “radial” and “radially” generally mean perpendicular to the given axis. For instance, an axial distance refers to a distance measured along or parallel to the axis, and a radial distance means a distance measured perpendicular to the axis.

Unless the context dictates the contrary, all ranges set forth herein should be interpreted as being inclusive of their endpoints, and open-ended ranges should be interpreted to include only commercially practical values. Similarly, all lists of values should be considered as inclusive of intermediate values unless the context indicates the contrary.

Certain terms are used throughout the description and claims to refer to particular features or components. As one skilled in the art will appreciate, different persons may refer to the same feature or component by different names. This document does not intend to distinguish between components or features that differ in name but not function.

While descriptions herein may relate to “comprising” various components or steps, the descriptions can also “consist essentially of” or “consist of” the various components and steps.

Unless otherwise indicated, all numbers expressing quantities are to be understood as being modified in all instances by the term “about” or “approximately”. Accordingly, unless indicated to the contrary, the numerical parameters are approximations that may vary depending upon the desired properties of the present disclosure.

What is claimed is:

1. A system for drilling a wellbore into a subterranean earth formation comprising:
a logging tool operable to measure formation data and locatable in the wellbore, wherein the logging tool comprises at least one near-range measurement sensor; and
a processor and a non-transitory memory device in data communication with the logging tool, wherein the non-transitory memory device comprises instructions that, when executed by the processor, cause the processor to:
receive, from the at least one near-range measurement sensor, near-range wellbore measurement data at each of a plurality of depths along the wellbore;
receive reference data related to a density measurement of the subterranean earth formation at each of the plurality of depths along the wellbore;
determine one or more near-range earth models of the subterranean earth formation at each of a plurality of depths along the wellbore derived from an inversion algorithm of the subterranean earth formation based on the near-range wellbore measurement data at each of the plurality of depths along the wellbore as constrained by the reference data, wherein each of the one or more near-range earth models comprises a density model of a layer of the subterranean earth formation;
receive a plurality of surface gravitational data, wherein each of the plurality of surface gravitational data is obtained at each of a plurality of surface locations proximate to the wellbore;
determine at least one of a mid-range formation model or a far-range formation model at each of the plurality of depths along the wellbore based on the one or more near-range earth models and the plurality of surface gravitational data; and
provide the at least one of the mid-range formation model or the far-range formation model to a well driller, wherein the well driller uses the at least one of the mid-range formation model or the far-range formation model for geosteering a drill bit into the subterranean earth formation.

2. The system of claim 1, wherein the at least one near-range measurement sensor comprises one or more of a wellbore acoustic sensor, a wellbore NMR sensor, a wellbore resistivity sensor, a wellbore gravimetric sensor, a pulse neutron sensor, a gamma ray source/gamma ray sensor, and a passive gamma detection sensor.

3. The system of claim 1, wherein the near-range wellbore measurement data comprise one or more of wellbore acoustic data, wellbore NMR data, wellbore resistivity data, neutron data, and gamma ray data.

4. The system of claim 1, wherein the reference data comprise data physically or directly indicative of the density of the subterranean earth formation at each of the plurality of depths along the wellbore.

5. The system of claim 4, wherein the reference data comprise one or more of a bulk density measurement of the subterranean earth formation, gamma ray source/gamma ray data, neutron density data, acoustic density data, photometric data, core sample data, cutting sample data, a formation fluid data, and down well composition data.

6. The system of claim 1, wherein the plurality of surface gravitational data are obtained from a plurality of surface gravity sensors, wherein each of the plurality of surface gravity sensors is located at each of the plurality of surface locations proximate to the wellbore.

7. The system of claim 1, wherein the plurality of surface gravitational data are obtained from at least one surface gravity sensor located sequentially at each of the plurality of surface locations proximate to the wellbore.

8. The system of claim 1, wherein the plurality of surface gravitational data are obtained from one or more quantum gravity sensors.

9. The system of claim 1, wherein the non-transitory memory device comprises instructions that, when executed by the processor, further cause the processor to correlate the at least one of the mid-range formation model or the far-range formation model at a first of the plurality of depths along the wellbore with the at least one of the mid-range formation model or the far-range formation model at a second of the plurality of depths along the wellbore, to determine one or more layer density inhomogeneities within one or more layers of the at least one of the mid-range formation model or the far-range formation model.

10. The system of claim 1, wherein the non-transitory memory device comprises instructions that, when executed by the processor, further cause the processor to constrain, the at least one of the mid-range formation model or the far-range formation model at each of the plurality of depths along the wellbore based on survey data.

11. The system of claim 1, wherein the non-transitory memory device comprises instructions that, when executed by the processor, further cause the processor to direct one or more of a depth or an orientation of the drill bit into the subterranean earth formation

12. A method drilling a wellbore into a subterranean earth formation comprising:
receiving, by a processor, near-range wellbore measurement data at each of a plurality of depths along the wellbore from one or more measurement sensors;
receiving, by the processor, reference data related to a density measurement of the subterranean earth formation at each of the plurality of depths along the wellbore;
determining, by the processor, one or more near-range earth models of the subterranean earth formation at each of a plurality of depths along the wellbore derived from an inversion algorithm of the subterranean earth formation based on the near-range wellbore measurement data at each of the plurality of depths along the wellbore as constrained by the reference data, wherein each of the one or more near-range earth models comprises a density model of a layer of the subterranean earth formation;
receiving, by the processor, a plurality of surface gravitational data, wherein each of the plurality of surface gravitational data is obtained at each of a plurality of locations proximate to the wellbore;
determining, by the processor, at least one of a mid-range formation model or a far-range formation model at each of the plurality of depths along the wellbore based on the one or more near-range earth models of the subterranean earth formation at each of the plurality of depths along the wellbore and the plurality of surface gravitational data; and
geosteering, by the well driller, a drill bit into the subterranean earth formation based on the at least one of the mid-range formation model or the far-range formation model.

13. The method of claim 12, wherein receiving near-range wellbore measurement data comprises receiving one or more of wellbore acoustic data, wellbore NMR data, wellbore resistivity data, neutron data, and gamma ray data.

14. The method of claim 12, wherein receiving reference data comprises receiving data physically or directly indicative of the density of the subterranean earth formation at each of the plurality of depths along the wellbore.

15. The method of claim 14, wherein receiving reference data comprises receiving one or more of a bulk density measurement of the subterranean earth formation, gamma ray source/gamma ray data, neutron density data, acoustic density data, photometric data, core sample data, cutting sample data, a formation fluid data, and down well composition data.

16. The method of claim 12, wherein receiving a plurality of surface gravitational data comprises receiving the plurality of surface gravitational data from a plurality of surface gravity sensors, wherein each of the plurality of surface gravity sensors is located at each of the plurality of surface locations proximate to the wellbore.

17. The method of claim 12, wherein receiving a plurality of surface gravitational data comprises receiving the plurality of surface gravitational data from at least one surface gravity sensor located sequentially at each of the plurality of surface locations proximate to the wellbore.

18. The method of claim 12, receiving a plurality of surface gravitational data comprises receiving the plurality of surface gravitational data from one or more quantum gravity sensors.

19. The method of claim 12, further comprising correlating, by the processor, the at least one of the mid-range formation model or the far-range formation model at a first of the plurality of depths along the wellbore with the at least one of the mid-range formation model or the far-range formation model at a second of the plurality of depths along the wellbore, to determine one or more layer density inhomogeneities within one or more layers of the at least one of the mid-range formation model or the far-range formation model.

20. The method of claim 12, further comprising constraining, by the processor, the at least one of the mid-range formation model or the far-range formation model at each of the plurality of depths along the wellbore based on survey data.

21. The method of claim 20, wherein constraining the at least one of the mid-range formation model or the far-range formation model based on survey data comprises constraining the at least one of the mid-range formation model or the far-range formation model based on one or more of geological survey data, acoustic survey data, or magnetic survey data.

22. The method of claim 12, further comprising geosteering, by the processor, a drill bit into the subterranean earth formation based on the at least one of the mid-range formation model or the far-range formation model.
